(19) United States
(12) Patent Application Publication
(10) Pub. No.: US 2026/0036960 A1
(43) Pub. Date: Feb. 5, 2026

(54) CONTROL STRUCTURE-AGNOSTIC EVENT-TRIGGERING

(71) Applicant: UNIVERSITY OF SOUTH FLORIDA, Tampa, FL (US)

(72) Inventors: Tansel YUCELEN, Tampa, FL (US); Deniz KURTOGLU, Tampa, FL (US); Eloy GARCIA, Dayton, OH (US); Dzung TRAN, Dayton, OH (US); David W. CASBEER, Dayton, OH (US)

(21) Appl. No.: 19/290,167

(22) Filed: Aug. 4, 2025

Related U.S. Application Data
(60) Provisional application No. 63/678,905, filed on Aug. 2, 2024.

(51) Int. Cl. G05B 19/045; G05B 23/02

(52) U.S. Cl. CPC G05B 19/045; G05B 23/0281

(57) ABSTRACT

Technology is disclosed for scheduling control data transmissions in a control system that operates independently of specific control structures. The method begins by receiving the current system state of a controlled electronic device. Using a model of the device, a nominal system state and corresponding control signal are estimated. An error signal is computed as the difference between the actual and nominal states. This error signal is used to adjust the nominal control signal via a feedback matrix. A previously transmitted control signal is retrieved, and an alignment metric is calculated by comparing the direction of the error signal with the change in control signals. The alignment metric is then evaluated against a condition derived from the magnitude of the error signal. If the condition is satisfied, the adjusted control signal is transmitted. This approach enables efficient and responsive control data scheduling, enhancing system performance while reducing unnecessary transmissions.

### CROSS-REFERENCE TO RELATED APPLICATION(S)

This application claims priority to U.S. Provisional Patent Application No. 63/678,905, filed on Aug. 2, 2024, the entire contents of which are incorporated herein by reference for all purposes.

### STATEMENT OF GOVERNMENT SUPPORT

This invention was made with government support under FA8650-21-D-2602 awarded by the Air Force Research Laboratory. The government has certain rights in the invention.

### BACKGROUND

Traditional event-triggered control systems rely heavily on the known structure of control laws to determine when control signals should be transmitted. These systems typically use Lyapunov-based stability criteria to derive event rules that suppress unnecessary control updates, thereby reducing communication load and improving energy efficiency. However, such approaches are limited in scope and applicability, especially in modern cyber-physical-human systems where control signals may be generated by opaque or non-deterministic processes such as human operators, reinforcement learning agents, or model predictive controllers.

In conventional settings, the control signal is often expressed in closed-form, allowing for straightforward derivation of stability conditions and event rules. For example, in a scalar system driven by a linear feedback control law, one can analytically derive conditions under which control updates are necessary. These conditions typically involve comparisons between the current state and the control signal, weighted by design parameters that ensure system stability.

However, in many emerging applications—including robotic surgery, drone swarm coordination, and underwater autonomous navigation—the control law may be unknown, nonlinear, or generated in real time by adaptive algorithms. In such cases, existing event-triggering frameworks fail to provide guarantees of stability or performance due to their reliance on structural assumptions.

### SUMMARY

The following presents a simplified summary of the disclosed technology herein in order to provide a basic understanding of some aspects of the disclosed technology. This summary is not an extensive overview of the disclosed technology. It is intended neither to identify key or critical elements of the disclosed technology nor to delineate the scope of the disclosed technology. Its sole purpose is to present some concepts of the disclosed technology in a simplified form as a prelude to the more detailed description that is presented later.

In some aspects, embodiments of the present disclosure provide systems and methods for scheduling control data transmissions in a control system without requiring knowledge of the underlying control law structure. The disclosed techniques enable event-triggered control in systems where the control signal may be generated by opaque or non-deterministic processes, such as human operators, machine learning models, or optimization-based controllers.

In one embodiment, a method is provided for scheduling control data transmissions based on a comparison between an error signal and a directional alignment metric. The method includes receiving a system state of a controlled electronic device, estimating a nominal system state and corresponding nominal control signal using a model of the device, and computing an error signal as the difference between the received and nominal states. An adjusted control signal is generated by modifying the nominal control signal using a feedback matrix. A directional alignment metric is computed between the error signal and the difference between the adjusted and previously transmitted control signals. This metric is compared to a threshold condition based on the magnitude of the error signal. If the condition is satisfied, the adjusted control signal is transmitted.

In another embodiment, a system is disclosed comprising a control device configured to perform the above method. The control device includes a processor and memory storing instructions to execute the event-triggering logic. The system may further include the controlled electronic device, which operates in response to the transmitted control signals.

In yet another embodiment, a non-transitory computer-readable medium is provided, storing instructions that, when executed by a processor, cause a control device to perform the method described above.

The disclosed technology supports both continuous-time and discrete-time linear time-invariant systems. The feedback matrix used to generate the adjusted control signal is selected such that the closed-loop system matrix is Hurwitz (for continuous-time) or Schur (for discrete-time). The directional alignment metric is computed using a matrix-weighted inner product, where the matrix is symmetric and positive-definite, satisfying a Lyapunov inequality.

These techniques enable control systems to operate efficiently in bandwidth-constrained or latency-sensitive environments, while maintaining stability and performance, even when the control law is unknown or unstructured.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims or may be learned by the practice of such embodiments as set forth hereinafter.

### BRIEF DESCRIPTION OF THE DRAWINGS

To describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings.

FIG. 1 illustrates an example system architecture including a vehicle and a controller, each comprising a processor, communications system, display, and memory.

FIG. 2 is a flowchart of an example method for control signal transmission based on system state alignment.

FIG. 3 illustrates an example computing system architecture comprising a processor, memory, instructions, data, input and output devices, display device and controller, communication interface, and a bus system.

FIG. 4 shows time-series plots of system states and control signals over time, including comparisons between nominal and actual states (x1(t), x2(t), xn1(t), xn2(t)) and control signals (u(t), Us(t), Un(t)).

FIG. 5 presents additional time-series plots similar to FIG. 4, showing variations in system states and control signals across time intervals, emphasizing dynamic behavior and control response.

FIG. 6 depicts plots of system states and control signals as functions of iteration index k, showing convergence behavior and control signal evolution across iterations.

FIG. 7 provides further iteration-based plots of system states and control signals, highlighting performance metrics and control signal adjustments over time

Before explaining the disclosed embodiment of this disclosure in detail, it is to be understood that the invention is not limited in its application to the details of the particular arrangement shown, as the invention is capable of other embodiments. Example embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

While the subject disclosure applies to embodiments in many different forms, there are shown in the drawings and will be described in detail herein specific embodiments with the understanding that the present disclosure is an example of the principles of the invention. It is not intended to limit the invention to the specific illustrated embodiments. The features of the invention disclosed herein in the description, drawings, and claims can be significant, both individually and in any desired combinations, for the operation of the invention in its various embodiments. Features from one embodiment can be used in other embodiments of the invention. In the description of the drawings, like reference numerals refer to like elements.

The present disclosure relates to systems and methods for scheduling control data transmissions in control systems, particularly in scenarios where the structure of the control law is unknown, unmodeled, or generated by non-deterministic processes. The disclosed technology enables control structure-agnostic event-triggering, which may be implemented in both continuous-time and discrete-time environments, and is compatible with a wide range of control signal sources, including human operators, learning-based agents, and optimization-based controllers.

In conventional control systems, event-triggering mechanisms often rely on explicit knowledge of the control law to determine when control updates should be transmitted. However, in many modern cyber-physical systems, the control signal may be generated by opaque or adaptive processes that do not lend themselves to closed-form analysis. The present disclosure addresses this limitation by introducing a framework that operates solely on the open-loop system dynamics and uses a feedback-based correction to stabilize the system without requiring access to the nominal control law.

In one embodiment, the system comprises a control device and a controlled electronic device, operatively coupled via a communication network. The control device may receive a system state of the controlled electronic device, estimate a nominal system state and a corresponding nominal control signal using a model of the device, and compute an error signal as the difference between the received and nominal states. An adjusted control signal is generated by modifying the nominal control signal using a feedback matrix. The control device then computes a directional alignment metric between the error signal and the difference between the adjusted and previously transmitted control signals. This metric is compared to a threshold condition based on the magnitude of the error signal. If the condition is satisfied, the adjusted control signal is transmitted; otherwise, the previously transmitted control signal is retained.

The disclosed framework supports both continuous-time and discrete-time linear time-invariant (LTI) systems. In continuous-time implementations, the feedback matrix may be selected such that the closed-loop system matrix is Hurwitz, ensuring exponential stability. In discrete-time implementations, the matrix may be selected to be Schur, ensuring stability under sampled-data operation. The directional alignment metric may be computed using a matrix-weighted inner product, where the weighting matrix is symmetric and positive-definite and satisfies a Lyapunov inequality.

This control structure-agnostic event-triggering framework may be applied in a variety of domains. For example, robotic surgery platforms benefit from precise control updates and minimal communication latency to ensure patient safety and responsiveness. Autonomous drone swarms require efficient control signaling to coordinate multiple agents under bandwidth constraints. Underwater autonomous vehicles rely on sparse acoustic communication and benefit from reduced transmission frequency. Spacecraft attitude control systems face telemetry delays and limited uplink opportunities, making intelligent scheduling of control updates essential. Smart manufacturing systems involve industrial robots operating in dynamic environments, often with control signals generated by adaptive or learning-based controllers. Additional applications include assistive exoskeletons, which incorporate human-in-the-loop control and must balance responsiveness with energy efficiency; remote-operated surgical training simulators, where control inputs from trainees are processed asynchronously and stability must be maintained despite unpredictable input patterns; and autonomous agricultural machinery, which operates in large outdoor environments with intermittent connectivity and must adapt to changing terrain and crop conditions.

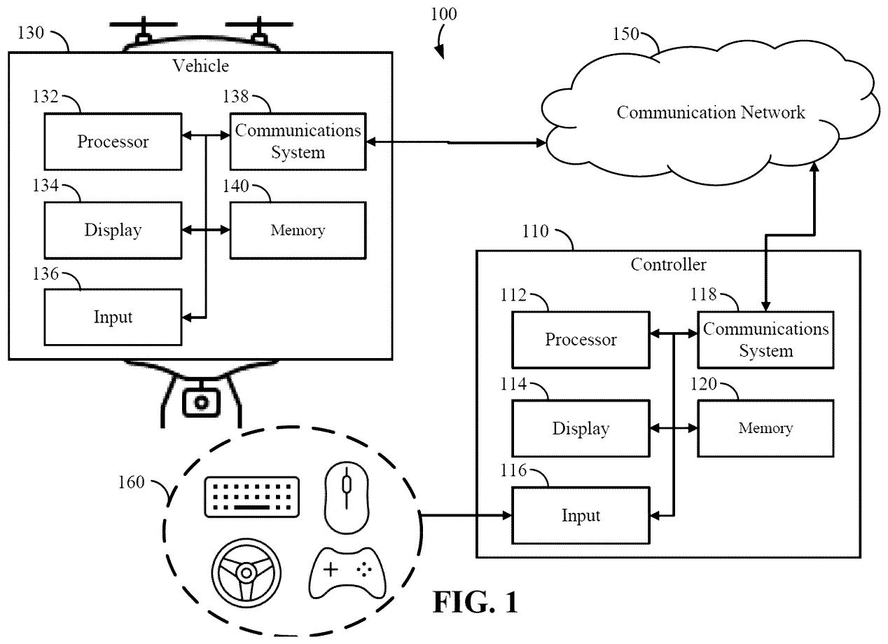

Referring now to FIG. 1, a schematic diagram illustrates an example system 100 configured to implement control structure-agnostic event-triggering. The system 100 comprises a control device (hereinafter referred to as controller 110), a controlled electronic device (hereinafter referred to as vehicle 130), and a communication network 150. The communication network 150 facilitates bidirectional data exchange between the controller 110 and the vehicle 130. The system 100 is operable to schedule control data transmissions by transmitting control signals only when a predefined event-triggering condition is violated, without requiring knowledge of the internal structure of the control law. This architecture is particularly advantageous in environments characterized by constrained communication bandwidth, variable latency, or stringent energy efficiency requirements. For instance, in remote robotic surgery, the system may suppress redundant control updates to mitigate latency and jitter; in drone swarm coordination, the system may adaptively modulate communication frequency based on proximity to a target; and in underwater autonomous vehicles, the system may minimize acoustic transmissions to conserve energy. These examples demonstrate the versatility of the system 100 across a range of domains, including but not limited to industrial automation, smart grid control, space exploration, and autonomous transportation.

The controller 110 may be implemented as a computing device configured to generate control signals based on received commands and the current state of the vehicle 130. In one embodiment, the controller 110 comprises a processor 112 and a memory 120 storing instructions that, when executed by the processor 112, cause the controller 110 to perform the operations described herein. The controller 110 may further include a display 114, an input interface 116, and a communications subsystem 118. The processor 112 may be configured to execute control logic, including operations for computing error signals, evaluating alignment metrics, and determining whether event-triggering conditions are satisfied. The processor 112 may further simulate a nominal trajectory using a nominal control signal, which may be generated by a human operator, a reinforcement learning agent, or an optimization-based controller. Examples of suitable processors include digital signal processors (DSPs), general-purpose central processing units (CPUs), and field-programmable gate arrays (FPGAs). The memory 120 may include flash memory, solid-state drives (SSDs), and dynamic random-access memory (DRAM). The controller 110 may be embodied as a wearable device, a desktop console, or a mobile computing unit.

The vehicle 130 may be any physical system subject to control, including but not limited to a drone, a robotic manipulator, an autonomous ground vehicle, or a surgical instrument. The vehicle 130 may comprise a processor 132 and a memory 140 storing instructions executable to apply received control signals to actuators. The vehicle 130 may further include a display 134, an input interface 136, and a communications subsystem 138. The processor 132 may be implemented as a microcontroller or a real-time processor. The memory 140 may include non-volatile storage, circular buffers, and volatile memory. The vehicle 130 may receive a sampled control signal uₛ(t) from the controller 110, which is held constant between triggering events using a zero-order hold mechanism.

The communication network 150 may include infrastructure such as Wi-Fi, 5G cellular networks, satellite relays, or mesh networks. The system state of the vehicle 130 may be received by the controller 110 either through direct measurement using sensors or via telemetry transmitted over the communication network 150. Sensors may include rotary encoders, inertial measurement units (IMUs), magnetometers, barometers, or RFID readers. Telemetry may be transmitted over Ethernet, wireless mesh networks, or satellite links.

The input device 160 may be configured to provide commands to the controller 110, such as desired trajectories, setpoints, or mission objectives. These commands may be entered manually or generated autonomously. The controller 110 may utilize these commands to estimate a nominal system state and a corresponding nominal control signal based on a model of the vehicle 130. The model may comprise a linear time-invariant (LTI) representation, including a feedback matrix selected such that the closed-loop system matrix is Hurwitz for continuous-time operation or Schur for discrete-time operation.

The controller 110 may determine an error signal e(t)=x(t)−x*(t), representing the deviation between the received system state and the estimated nominal system state. An adjusted control signal u(t)=u*(t)−Le(t) may be generated by modifying the nominal control signal based on the error signal using the feedback matrix L. The adjusted control signal may be filtered or saturated to comply with actuator constraints.

The controller 110 may retrieve a previously transmitted control signal uₛ(t), which was last sent to the vehicle 130. The signal uₛ(t) may be held constant between triggering events using a zero-order hold mechanism, such that uₛ(t)=u(tₖ) for t∈[tₖ, tₖ₊₁). The controller 110 may maintain a buffer of transmitted signals and timestamps to track update history.

The controller 110 may compute an alignment metric based on a directional comparison between the error signal and the difference between the adjusted control signal and the previously transmitted control signal. The directional comparison may comprise computing a matrix-weighted inner product 2e^{τ}(t)PB(uₛ(t)−u(t)), where the matrix P is symmetric and positive-definite and satisfies a Lyapunov inequality. The alignment metric quantifies the directional consistency between the control correction and the system deviation.

The alignment metric may be compared to a condition comprising a scalar multiple of the norm of the error signal. Specifically, the event-triggering condition may be defined as 2e^{τ}(t)PB(uₛ(t)−u(t))≤αe^{τ}(t)e(t), where α is a design parameter. If the condition is satisfied, the adjusted control signal may be suppressed, and the previously transmitted signal may be retained. Otherwise, the adjusted control signal may be transmitted to the vehicle 130.

Upon determining that the event-triggering condition is violated, the controller 110 may transmit the adjusted control signal to the vehicle 130. The vehicle 130 may execute the received control signal using actuators, which may include motors, servos, or hydraulic systems. In some implementations, the vehicle 130 may include a local safety controller configured to monitor signal integrity and override commands if necessary.

The system 100 may support both continuous-time and discrete-time implementations. In continuous-time configurations, the controller 110 may receive high-frequency state updates and evaluate the triggering condition in real time. In discrete-time configurations, the controller 110 may operate at fixed sampling intervals and support asynchronous communication. The control structure-agnostic framework may accommodate both configurations without requiring changes to the core logic.

The system 100 may be embodied in a method, a system, or a non-transitory computer-readable medium storing instructions executable to perform the method. The system 100 may be integrated into existing control frameworks with minimal modification and may be extended to nonlinear or time-varying systems. Example deployments may include robotic surgery platforms, autonomous drone fleets, smart building HVAC systems, and wearable assistive devices.

In one embodiment, the system 100 is configured to operate in a continuous-time environment. In such an embodiment, the controller 110 is operable to receive a system state of the vehicle 130 either through direct measurement using one or more onboard sensors or via telemetry received over the communication network 150. The system state may comprise one or more physical parameters, including but not limited to position, velocity, orientation, temperature, or joint angles, depending on the specific application. For example, in a robotic surgical system, the system state may include tool tip position and joint velocities; in a satellite platform, the system state may include angular momentum and attitude; and in an unmanned aerial vehicle (UAV), the system state may include GPS coordinates and inertial measurements. The sensors used to obtain such measurements may include rotary encoders, inertial measurement units (IMUs), magnetometers, barometers, or pressure sensors. The telemetry data may be transmitted over a variety of communication infrastructures, including but not limited to wireless mesh networks, 5G cellular links, or satellite relay systems.

Upon receiving the system state, the controller 110 may estimate a nominal system state and a corresponding nominal control signal based on a model of the vehicle 130. The model may comprise a linear time-invariant (LTI) representation of the system dynamics, expressed as \dot{x}*(t)=Ax*(t)+Bu*(t), where A and B are system and input matrices, respectively. A feedback matrix L may be selected such that the closed-loop system matrix Aₑ=A−BL is Hurwitz, thereby ensuring exponential stability of the error dynamics in continuous-time operation. For example, in a UAV, the model may represent translational and rotational dynamics; in a robotic manipulator, the model may represent joint kinematics and actuator response; and in a smart grid actuator, the model may represent voltage regulation behavior. The nominal control signal u*(t) may be generated by a human operator, a learning-based controller, or an optimization algorithm, and may be nonlinear or opaque in structure.

The controller 110 may compute an error signal e(t)=x(t)−x*(t), representing the deviation between the actual and nominal system states. An adjusted control signal u(t)=u*(t)−Le(t) may be generated using the feedback matrix L to stabilize the error dynamics. The adjusted control signal may be filtered or subject to saturation limits to ensure compliance with actuator constraints and to prevent abrupt transitions. For example, in a robotic arm, the adjusted signal may include torque corrections; in a UAV, it may include thrust vector adjustments; and in a prosthetic limb, it may include motor voltage commands. The controller 110 may also log the error signal and control history for diagnostic and performance monitoring purposes.

The controller 110 may retrieve a previously transmitted control signal uₛ(t), which was last sent to the vehicle 130. The signal uₛ(t) may be held constant between triggering events using a zero-order hold mechanism, such that uₛ(t)=u(tₖ) for t ∈[tₖ, tₖ₊₁). The controller 110 may maintain a buffer of transmitted signals and associated timestamps to track update history. This mechanism ensures that the vehicle 130 continues to operate even in the absence of new control transmissions. For example, in a surgical robot, the manipulator may maintain its pose during network latency; in a UAV, the flight controller may hold the last velocity command; and in an underwater vehicle, the thruster may maintain its last power setting. The zero-order hold mechanism may be implemented in software or hardware and may include timeout safeguards to prevent the application of stale data.

The controller 110 may compute an alignment metric based on a directional comparison between the error signal and the difference between the adjusted control signal and the previously transmitted control signal. The directional comparison may comprise computing a matrix-weighted inner product 2e^{τ}(t)PB(uₛ(t)−u(t)), where the matrix P is symmetric and positive-definite and satisfies a Lyapunov inequality. The alignment metric quantifies the directional consistency between the control correction and the system deviation.

The alignment metric may be compared to a condition comprising a scalar multiple of the norm of the error signal. Specifically, the event-triggering condition may be defined as 2e^{τ}(t)PB(uₛ(t)−u(t))≤αe^{τ}(t)e(t), where α is a design parameter. If the condition is satisfied, the adjusted control signal may be suppressed, and the previously transmitted signal may be retained. Otherwise, the adjusted control signal may be transmitted to the vehicle 130.

The continuous-time implementation of the system 100 is particularly well-suited for applications involving high-fidelity dynamics and limited communication bandwidth. Example applications include satellite attitude control systems employing reaction wheels and magnetorquers, long-range UAVs operating over intermittent telemetry links, and underwater autonomous vehicles utilizing acoustic modems. These systems benefit from reduced control data transmissions, improved energy efficiency, and guaranteed stability under sparse updates. The control structure-agnostic framework described herein enables integration with human-in-the-loop, learning-based, and optimization-based controllers, even when the structure of the control law is unknown or not explicitly defined.

In another embodiment, the system 100 is configured to operate in a discrete-time environment. In such an embodiment, the controller 110 may receive system state measurements at discrete time steps tₖ, either via onboard sensors or over the communication network 150. The system state may include sampled values of physical parameters such as position, velocity, orientation, or other variables relevant to the control objective. For example, in an autonomous vehicle, the system state may include wheel encoder readings and IMU data; in a warehouse robot, it may include floor marker localization and battery status; and in a smart grid actuator, it may include voltage and current samples. Sensors used to obtain such measurements may include digital encoders, barometers, or RFID readers. Communication may occur over Ethernet, Wi-Fi, or low-power wireless protocols, depending on the deployment environment.

Upon receiving the system state, the controller 110 may estimate a nominal system state and a corresponding nominal control signal using a model of the vehicle 130. The model may comprise a linear time-invariant representation of the system dynamics, expressed as x*(k+1)=Ax*(k)+Bu*(k), where A and B are system and input matrices, respectively. A feedback matrix L may be selected such that the closed-loop system matrix Ae=A-BL is Schur, thereby ensuring stability of the error dynamics in discrete-time operation. For example, in a robotic forklift, the model may represent drive and lift dynamics; in a UAV, it may represent discrete-time flight control; and in a prosthetic limb, it may represent gait phase transitions. The nominal control signal u*(k) may be generated by a reinforcement learning agent, a human operator, or a model predictive controller.

The controller 110 may compute an error signal e(k)=x(k)−x*(k) at each discrete time step. An adjusted control signal u(k)=u*(k)−Le(k) may be generated using the feedback matrix and the error signal. The controller 110 may retrieve the previously transmitted control signal uₛ(k−1) and compute an alignment metric using a directional comparison between the error signal and the difference between the adjusted and previously transmitted control signals. The directional comparison may comprise computing a matrix-weighted inner product 2e^{τ}(k) PB (uₛ(k−1)−u(k)), where P is a symmetric positive-definite matrix that satisfies the discrete-time Lyapunov equation

$${A}_{e}^{T} {PA}_{e} - P + R = 0$$

a user-dermed matrix R. The weighting matrix P may be selected to emphasize critical state dimensions, such as heading error in UAVs or torque deviation in robotic arms.

The alignment metric may be compared to a condition comprising a scalar multiple of the norm of the error signal. Specifically, the event-triggering condition may be defined as 2e^{τ}(k)PB(uₛ(k−1)−u(k))≤αe^{τ}(k)e(k), where α is a design parameter. If the condition is satisfied, the adjusted control signal may be suppressed, and the previously transmitted signal may be retained. Otherwise, the adjusted control signal may be transmitted to the vehicle 130.

The discrete-time implementation of the system 100 is particularly well-suited for digital control systems, including but not limited to embedded controllers in autonomous vehicles, industrial robots, and smart grid actuators. This implementation supports asynchronous communication and computation, thereby reducing the need for synchronized clocks or high-rate sampling. Example deployments include mobile robots utilizing microcontrollers with real-time operating systems, HVAC controllers implemented using programmable logic controllers, and prosthetic limbs employing embedded processors with gait phase detection. The control structure-agnostic framework described herein enables integration with a wide range of control strategies and ensures system stability under sparse control updates.

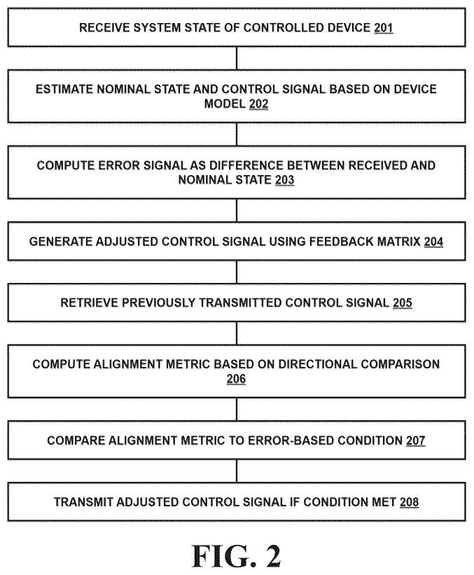

Referring now to FIG. 2, a flowchart is illustrated that depicts an example method for scheduling control data transmissions in a control system. The method may reduce unnecessary communication between a control device and a controlled electronic device by selectively transmitting control signals only when a triggering condition is met. This approach may be applied in networked control systems where bandwidth, latency, or energy constraints limit the feasibility of continuous data exchange. The method may be implemented in embedded systems, cloud-based controllers, or distributed control architectures. For example, in autonomous drones used for agricultural monitoring, the control device may be a flight controller running open-source firmware, which interfaces with telemetry radios and satellite navigation modules to manage flight paths while minimizing control signal transmissions. In such systems, the drone may be equipped with a GNSS receiver and a long-range telemetry radio communicating with a ground station running mission planning software. The control logic may be executed on a 32-bit microcontroller, and the event-triggering mechanism may be implemented as a protocol extension that suppresses redundant control packets. This configuration allows the drone to maintain stable flight while conserving bandwidth and battery life during long-range missions.

The control device may be realized as a computing node comprising a processor and a memory. The processor may include a digital signal processor (DSP), a general-purpose CPU, or a field-programmable gate array (FPGA). The memory may store instructions that, when executed by the processor, cause the control device to perform the operations described herein. These operations may be executed in real-time or near-real-time depending on the application. In industrial robotics, for instance, the control device may be a programmable logic controller (PLC) with integrated motion control modules and industrial Ethernet connectivity, executing ladder logic or structured text routines to manage robotic arm movements. In a real-world packaging line, the PLC may control a six-axis robotic arm, with feedback from encoders and proximity sensors processed via a deterministic fieldbus protocol. The event-triggering logic may be embedded in the PLC's cyclic task scheduler, using structured text to evaluate alignment metrics and suppress unnecessary actuator updates. This setup ensures precise motion control while reducing network traffic between the PLC and the robot.

At step 201, the control device receives a system state of the controlled electronic device. This state may be acquired through direct measurement using onboard sensors such as accelerometers, gyroscopes, magnetometers, or encoders. Alternatively, the state may be received via telemetry over a communication network, which may include wireless mesh networks, cellular infrastructure, satellite relays, or Ethernet links. The system state is denoted as x(t)∈ [symbol] ⁿ, where n is the dimension of the state vector. In autonomous vehicles, this state may be collected using a combination of LiDAR, radar, and camera systems, with data fused using an extended Kalman filter and transmitted over a vehicle bus or Ethernet to the control unit. In a real-world implementation, the control unit may be an industrial-grade computer running a robotics middleware framework, with sensor fusion performed using a localization module and state updates published over a real-time communication protocol.

The system state represents the current condition of the controlled device and is used to assess deviations from expected behavior. In some implementations, the control device may preprocess the received state to filter noise, interpolate missing data, or transform coordinates into a reference frame suitable for control. For example, in underwater autonomous vehicles, inertial navigation systems (INS) such as Doppler velocity logs may be used to estimate position and velocity, with preprocessing performed using onboard microcontrollers running real-time operating systems. In a typical autonomous underwater vehicle, the control system may use a combination of velocity sensors, pressure sensors, and magnetometers, with sensor fusion performed using a custom Kalman filter implemented in C on a single-board computer. The event-triggering logic may be integrated into the mission control loop, evaluating state deviations before issuing thruster commands. This allows the vehicle to maintain course with minimal control updates, conserving energy during extended missions.

At step 202, the control device estimates a nominal system state x*(t)∈ [symbol] ⁿ and a corresponding nominal control signal u*(t)∈ [symbol] ⁿ based on a model of the controlled electronic device. The model may comprise a linear time-invariant (LTI) representation of the system dynamics, expressed as:

$${\dot{x}}^{★} ( t ) = {Ax}^{★} ( t ) + {Bu}^{★} ( t ) , {x}^{★} ( 0 ) = {x}_{0}^{★}$$

where A∈ [symbol] ^{n×n} is the system matrix and B E [symbol] ″xm is the control input matrix. The pair (A, B) is assumed to be controllable, meaning that the system can be driven from any initial state to any desired state using an appropriate control input.

In smart grid applications, the nominal model may be derived from linearized power flow equations, with control signals generated by optimization solvers running on edge servers. In a real-world microgrid, the controller may be a grid automation server, which uses standardized communication protocols to interface with distributed energy resources. The nominal control signal may be computed using a model predictive control (MPC) algorithm implemented in a high-level programming language and deployed via containerized services on an edge computing platform. This configuration enables predictive load balancing while minimizing control traffic across the grid.

The nominal control signal u*(t) may be generated by a human operator, a reinforcement learning agent, or an optimization-based controller. Importantly, the structure of u*(t) is not required to be known or fixed. This allows the framework to accommodate control laws that are opaque, nonlinear, or data-driven. In robotic surgery systems, for example, nominal control signals may be generated by a surgeon manipulating a haptic interface, with the control device interpreting joystick movements and force feedback using a combination of PID controllers and neural networks deployed on embedded computing modules. In a typical surgical robot, the surgeon's hand movements are captured by magnetic encoders and processed by a real-time operating system running on an ARM-based board. The nominal trajectory is computed using inverse kinematics, and the control signal is transmitted to servo motors via a real-time fieldbus protocol. The event-triggering logic may be embedded in the motion control firmware to suppress redundant updates during steady-state tool positioning.

At step 203, the control device computes an error signal e(t)∈ [symbol] ⁿ as the difference between the received system state and the estimated nominal system state:

$$e ( t ) x ( t ) - {x}^{★} ( t )$$

This error signal quantifies the deviation of the actual system trajectory from the nominal trajectory. It serves as a diagnostic indicator of how far the system has drifted from its expected behavior. The error signal is central to the event-triggering logic, as it determines whether corrective action is warranted. In aerospace applications, such as satellite attitude control, the error signal may be computed using quaternion-based orientation estimates from star trackers and gyroscopes, with the difference evaluated in a body-fixed reference frame. For example, in a small satellite platform, the attitude determination and control system may use a Kalman filter to estimate orientation and angular velocity, and the error signal is computed onboard using a radiation-hardened FPGA. The event-triggering logic may be implemented in hardware description language to determine whether to activate magnetorquers or reaction wheels.

The error signal may be used to assess system performance, detect faults, or trigger safety mechanisms. In some implementations, the control device may compute additional metrics such as the norm of the error, its rate of change, or its projection onto specific subspaces to inform control decisions. For instance, in automated warehouse systems, deviations in robotic forklift trajectories may be detected using laser rangefinders and RFID tags, with error signals processed by low-power processors running a robotics middleware framework. In a typical warehouse automation system, the error signal may be derived from wheel encoder feedback and floor marker localization, with deviations triggering corrective maneuvers.

The event-triggering logic may be implemented as a software node that publishes control updates only when the error exceeds a configurable threshold. At step 204, the control device generates an adjusted control signal u(t)∈ [symbol] ^{m} by modifying the nominal control signal based on the error signal using a feedback matrix L∈ [symbol] ^{m×n} . The adjusted control signal is defined as:

$$u ( t ) = {u}^{★} ( t ) - Le ( t )$$

The feedback matrix L is selected such that the closed-loop system matrix Aₑ=A−BL is Hurwitz in continuous-time or Schur in discrete-time, thereby ensuring stability of the error dynamics.

In multi-agent robotic systems, the feedback matrix may be computed using distributed consensus algorithms implemented on low-power microcontrollers, with control signals broadcast over low-bandwidth wireless protocols. For example, each robot in a swarm may use a local feedback matrix to adjust its heading and velocity based on deviations from a shared formation pattern. The adjusted control signal may be applied to motor controllers via pulse-width modulation (PWM) signals generated by the onboard processor. The adjusted control signal u(t) is designed to counteract deviations and guide the system back toward its nominal trajectory. It may be computed using state feedback, output feedback, or observer-based techniques. In adaptive implementations, the feedback matrix L may be updated online using system identification or learning algorithms.

For example, in building automation systems, feedback gains may be tuned using recursive estimation algorithms running on embedded controllers interfaced with environmental sensors. In a commercial HVAC system, the control logic may be implemented in programmable controllers that adjust airflow and temperature based on occupancy and thermal load. The event-triggering mechanism may be embedded in the control firmware to reduce actuator wear and optimize energy efficiency.

At step 205, the control device retrieves a previously transmitted control signal uₛ(t)∈ [symbol] ^{m}, which represents the last control input applied to the controlled electronic device. This signal is held constant between triggering events using a zero-order hold mechanism, such that:

$${u}_{s} ( t ) = u ( {t}_{k} ) , t ∈ [ {t}_{k} , {t}_{k + 1} )$$

where tₖ denotes the time of the last triggering event. This mechanism ensures that the system continues to operate even in the absence of new control transmissions, thereby reducing communication load. In wearable assistive devices, zero-order hold may be implemented using digital-to-analog converters that maintain actuator voltages between updates, with control logic executed on embedded processors. For example, a powered exoskeleton may hold joint torque commands constant between updates, using PWM signals to drive motors at the hip and knee joints. The event-triggering logic may be implemented in firmware to determine when to refresh the control signal based on gait phase transitions.

The zero-order hold may be implemented in software or hardware and may include safeguards to prevent stale data from being applied indefinitely. In some cases, a timeout mechanism may be used to force transmission if no event occurs within a specified interval. For example, in autonomous underwater vehicles, control signals may be refreshed periodically using watchdog timers embedded in mission control software to ensure responsiveness despite intermittent communication. In a typical glider system, the control signal may be applied to a buoyancy engine and rudder actuators, with zero-order hold implemented in the vehicle's mission executive software. The timeout mechanism may be configured via mission scripts to ensure periodic updates even in the absence of significant state deviations.

At step 206, the control device computes an alignment metric based on a directional comparison between the error signal and the difference between the adjusted control signal and the previously transmitted control signal. The directional comparison is performed using a matrix-weighted inner product:

$$AlignmentMetric = 2 {e}^{⊤} ( t ) PB ( {u}_{s} ( t ) - u ( t ) )$$

where P∈ [symbol] ^{n×n} is a symmetric positive-definite matrix that satisfies the continuous-time Lyapunov equation:

$${A}_{e}^{⊤} P + {PA}_{e} + R = 0$$

for a user-defined matrix R∈ [symbol] ^{n×n}. This alignment metric captures the directional consistency between the control correction and the system deviation. A high alignment value indicates that the control update is well-aligned with the error and likely to be effective. In prosthetic limb systems, this metric may be computed using deviations in electromyographic signals and joint torque measurements, with matrix operations performed on embedded processors. The alignment metric may be evaluated in real time to determine whether to update motor commands based on user intent and limb position. The matrix P may be computed offline or updated online using Lyapunov-based design methods.

The choice of R affects the sensitivity of the triggering condition and may be tuned to balance performance and communication cost. In high-speed transportation systems, these matrices may be derived from linearized vehicle dynamics and computed using simulation models deployed on real-time control platforms. For example, a train control system may use a real-time model of traction and braking dynamics to compute P and R, with updates transmitted over a deterministic vehicle bus. The event-triggering logic may be implemented in real-time software to reduce control chatter while maintaining ride comfort and safety.

At step 207, the control device compares the alignment metric to a condition based on the magnitude of the error signal. The event-triggering condition is defined as:

$$2 {e}^{⊤} ( t ) PB ( {u}_{s} ( t ) - u ( t ) ) \leq α {e}^{⊤} ( t ) e ( t )$$

where α∈ [symbol] ₊ is a design constant chosen such that

$$R - α {I}_{n} ∈ {ℝ}_{+}^{n \times n} .$$

This condition ensures that control updates are only transmitted when the deviation from the nominal trajectory exceeds a threshold that justifies communication. The inequality is norm-free, meaning it does not rely on absolute values or norms, which allows for fewer control transmissions compared to norm-based conditions.

As another example, in precision agriculture systems, this condition may be evaluated using soil moisture sensor data and valve control signals, with logic executed on microcontroller-based irrigation controllers. The event-triggering logic may be implemented in embedded software to reduce valve actuation frequency and extend system life. The triggering condition may be evaluated periodically or continuously depending on system requirements.

In some implementations, a hysteresis mechanism may be added to prevent chattering near the threshold. For example, in autonomous cleaning robots, control updates may be triggered only if deviation persists for a specified duration, with logic implemented in lightweight scripting languages running on embedded processors. The control logic may use a combination of wheel encoder data and localization algorithms to detect deviations from planned paths. The event-triggering condition may be evaluated in real time, with control updates sent to the drive motors only when deviation exceeds a configurable margin.

At step 208, the control device transmits the adjusted control signal u(t) to the controlled electronic device if the event-triggering condition is violated. Otherwise, the previously transmitted control signal uₛ(t) is retained and applied. The controlled electronic device may apply the received control signal via actuators and may include fallback routines to maintain safety in the absence of new control inputs. In robotic surgical systems, control signals may be transmitted over real-time communication links to servo controllers, with fallback routines executed on redundant processors to ensure patient safety.

The control signal may be transmitted from a master console to an arm controller via a deterministic fieldbus protocol, with fallback routines implemented in a safety-certified real-time operating system. The event-triggering logic may be embedded in the arm controller firmware to reduce control latency and improve responsiveness. The transmission may occur over wired or wireless channels and may include encryption, authentication, or error correction to ensure reliability. The control device may log transmission events for diagnostics or performance analysis. In autonomous industrial vehicles, control signals may be sent over cellular networks with secure transport protocols, and logs stored in relational databases for fleet management.

The control unit may use a wireless gateway to transmit control packets to the vehicle's onboard controller, which applies the signal to steering and throttle actuators. The event-triggering logic may be implemented in compiled code and deployed via containerized services on an edge computing gateway. The error dynamics of the system under the event-triggered control policy are given by:

$$e ( t ) = {A}_{e} e ( t ) + B ( {u}_{s} ( t ) - u ( t ) )$$

This equation shows that the error evolves according to the closed-loop dynamics and the difference between the sampled and adjusted control signals. The stability of the system is analyzed using the Lyapunov function:

$$V ( e ) = {e}^{⊤} Pe$$

whose time derivative satisfies:

$$\dot{V} ( e ) = {e}^{⊤} ( t ) Re ( t ) + 2 {e}^{⊤} ( t ) PB ( {u}_{s} ( t ) - u ( t ) )$$

Using the event-triggering condition (7), it follows that:

$$\dot{V} ( t ) \leq - {e}^{⊤} ( t ) ( R - α {I}_{n} ) e ( t )$$

Letting R₁=R−αIₙ, we obtain:

$$\dot{V} ( t ) \leq \frac{{λ}_{min} ( {R}_{1} )}{{λ}_{max} ( P )} V ( t ) = - {β}_{1} V ( t )$$

which implies exponential stability of the origin:

$$V ( t ) \leq {V}_{0} exp ( - {β}_{1} t ) where {V}_{0} = {e}_{0}^{⊤} {Pe}_{0} .$$

Thus, the error signal e(t) vanishes exponentially over time, ensuring that the system remains stable under the event-triggered control policy. The stability analysis confirms that the proposed method maintains system performance while reducing communication. This is particularly valuable in applications such as satellite attitude control, underwater robotics, and remote surgery, where communication is costly or constrained. In each case, the Lyapunov-based guarantees provide confidence that the system will remain within safe operating bounds even with sparse control updates. These guarantees are especially important in safety-critical systems where over-or under-actuation could lead to mission failure or harm. The method's ability to ensure stability without requiring knowledge of the control law structure makes it broadly applicable across domains.

The architecture of FIG. 2 supports control structure-agnostic event-triggering and may be particularly effective in scenarios where the control law is not known in closed form. Example implementations include autonomous vehicles operating under human-in-the-loop control, reinforcement learning-based controllers, and optimization-driven systems. In experimental studies, the method has demonstrated significant reductions in control data transmissions.

A robotic surgery system illustrates an example implementation of the method illustrated in FIG. 2 in which a surgeon operates remotely from the patient. The system comprises a remote surgical console, a communication network, and a patient-side robotic manipulator. The remote console includes input devices such as haptic joysticks, foot pedals, and visual displays, which the surgeon uses to generate control inputs. These inputs are transmitted over a network link to the patient-side system, which includes actuators, sensors, and a control device. The control device executes the method of FIG. 2 to determine when control signals should be transmitted to the robotic manipulator. For example, this approach may support scenarios where the network link is subject to bandwidth constraints or intermittent disruptions, such as in rural or mobile surgical deployments.

At step 201, the control device receives the system state of the patient-side robotic manipulator. The system state vector x(t)∈ [symbol] ¹² may include joint angles (6 values), joint angular velocities (6 values), and optionally tool tip position and orientation if Cartesian control is used. These values are obtained from components, such as rotary encoders, inertial measurement units (IMUs), and force-torque sensors embedded in the robotic arms and surgical tools.

The control device may be implemented using a real-time embedded processor with sensor interfaces and a local memory buffer. The system state is sampled at a high frequency (e.g., 1 kHz) and may be preprocessed to remove noise and outliers. In some implementations, the system state is also timestamped and synchronized with the surgeon's input stream to enable accurate alignment.

At step 202, the control device estimates a nominal system state x*(t)∈ [symbol] ¹² and a corresponding nominal control signal u*(t)∈ [symbol] ⁶ based on a model of the robotic manipulator. The model is a linearized representation of the manipulator dynamics around a nominal operating point, expressed as \dot{x}*(t)=Ax*(t)+Bu*(t). The matrix A∈ [symbol] ^{12×12} may include blocks representing joint dynamics and coupling effects, while B∈ [symbol] ^{12×6} maps control inputs to joint accelerations. The nominal control signal u*(t) includes desired joint torques or velocities derived from the surgeon's input device. These values are transmitted over the network and used to simulate the expected trajectory of the manipulator. The simulation may use techniques such as fixed-step Runge-Kutta integrator, a real-time solver, etc.

At step 203, the control device computes an error signal e(t)=x(t)−x*(t)∈ [symbol] ¹². representing the deviation between the actual and nominal system states. This error signal is used to assess whether the manipulator is following the intended trajectory. The error may be computed in joint space or Cartesian space, depending on the control architecture. For example, if Cartesian control is used, the error may include deviations in tool tip position and orientation. The control device may also compute the Euclidean norm ∥e(t)∥₂, directional projections, or weighted norms to assess the significance of the deviation. The error signal is stored in a buffer and used to determine whether a control update is necessary.

At step 204, the control device generates an adjusted control signal u(t)=u*(t)−Le(t)∈ [symbol] ⁶, where L∈ [symbol] ^{6×12} is a feedback matrix designed to stabilize the error dynamics. The matrix L may be computed offline using linear quadratic regulator (LQR) techniques, with a cost function defined by matrices Q_{L}∈ [symbol] ^{12×12} and R_{L}∈ [symbol] ^{6×6}. For example, Q_{L} may be a diagonal matrix with higher weights on tool tip position errors, and R_{L} may penalize large control efforts. The adjusted control signal compensates for deviations and guides the manipulator back toward the nominal trajectory. It may be subject to saturation limits and filtered to prevent abrupt changes.

At step 205, the control device retrieves the previously transmitted control signal uₛ(t)∈ [symbol] ⁶, which was last sent to the robotic manipulator. This signal is held constant between triggering events using a zero-order hold mechanism. The control device maintains a buffer of transmitted signals and timestamps to track the most recent update. The zero-order hold ensures that the manipulator continues to operate even when no new control signal is transmitted. This mechanism is particularly important in remote surgery scenarios where network disruptions may prevent timely updates. The previously transmitted signal is used to evaluate whether a new transmission is necessary.

At step 206, the control device computes an alignment metric based on the directional comparison between the error signal and the difference between the adjusted and previously transmitted control signals. The metric is computed as 2e^{τ}(t)PB(uₛ(t)−u(t)), where P∈ [symbol] ^{12×12} is a symmetric positive-definite matrix satisfying the Lyapunov equation

$${A}_{e}^{⊤} P + {PA}_{e} + R = 0.$$

The matrix R∈ [symbol] ^{12×12} may be chosen as a diagonal matrix with higher weights on critical joints or tool tip deviations. The alignment metric quantifies whether the control correction is aligned with the system deviation. A high alignment value indicates that the control update is likely to reduce the error.

At step 207, the control device compares the alignment metric to an error-based condition to determine whether a control update should be transmitted. The condition is defined as 2e^{τ}(t)PB(uₛ(t)−u(t))≤αe^{τ}(t) e(t), where α∈ [symbol] ₊ is a design parameter. The scalar α may be tuned based on the desired trade-off between control performance and communication efficiency. For example, a lower α results in more frequent updates, while a higher α suppresses transmissions unless the error is significant. If the condition is satisfied, the control update is deemed unnecessary and suppressed. If the condition is violated, the control update is transmitted to the manipulator.

At step 208, the control device transmits the adjusted control signal u(t) to the robotic manipulator if the triggering condition is violated. The signal is transmitted over the network using a real-time communication protocol with encryption and error correction. The control device may also log the transmission event for diagnostic purposes. If the condition is satisfied, the previously transmitted signal uₛ(t) is retained and applied. The manipulator executes the received control signal using its actuator drivers and motion controllers. In some implementations, the manipulator includes a local safety controller that monitors signal integrity and overrides commands if necessary.

The error dynamics of the system under the event-triggered control policy are governed by ė(t)=Aₑe(t)+B(uₛ(t)−u(t)). The control device analyzes the stability of the error dynamics using a Lyapunov function V(e)=e^{τ}Pe. The time derivative of the Lyapunov function is computed as \dot{V}(t)=−e^{τ}(t)Re(t)+2e^{τ}(t)PB(uₛ(t)−u(t)). Using the triggering condition, it follows that \dot{V}(t)≤−e^{τ}(t)(R−αIₙ)e(t), which implies exponential stability. The control device uses this analysis to ensure that the error signal vanishes over time. This guarantees that the manipulator remains stable even with sparse control updates. The application of the method to remote robotic surgery provides significant advantages in terms of bandwidth efficiency and system stability.

By suppressing unnecessary control transmissions, the method reduces network load and improves responsiveness. This is particularly important in scenarios where the surgeon operates over a constrained or unreliable network link. The method ensures that control updates are transmitted only when they are expected to improve performance, reducing latency and jitter. The stability guarantees provided by the Lyapunov analysis ensure that the manipulator remains safe and accurate.

The method can be integrated into existing surgical systems with minimal modifications. The components used to implement the method include a remote surgical console, a patient-side robotic manipulator, a real-time control device, and a communication network. The control device includes a processor, memory, sensor interfaces, and actuator drivers. The processor executes the method steps using stored models and parameters. The memory stores system states, control signals, and matrices such as A, B, L, P, and R. The sensor interfaces acquire measurements from encoders, force sensors, and inertial units. The actuator drivers apply control signals to motors and actuators. The communication network transmits control signals and feedback between the surgeon and the patient-side system. The method ensures that this transmission is efficient and reliable, even under challenging network conditions.

A drone swarm implemented using the method of FIG. 2 applied to a search and rescue operation provides another example of how the disclosed technology may be applied. In this example, the swarm comprises a leader drone and multiple follower drones, each equipped with sensors, actuators, and communication modules. The leader drone acts as the control device, issuing guidance commands to the followers based on mission objectives and environmental feedback. The follower drones operate semi-autonomously but rely on periodic control updates from the leader to maintain formation, avoid obstacles, and converge on target locations. The control method is particularly useful in environments with intermittent connectivity, such as urban canyons, dense forests, or disaster zones, where bandwidth is limited and signal disruptions are common.

At step 201, the leader drone receives the system state of each follower drone. The system state vector xᵢ(t)∈ [symbol] ⁹ for drone i includes position coordinates (x, y, z), velocity components (vₓ, v_{y}, v_{z}), and orientation angles (roll, pitch, yaw). These values may be obtained from devices such as onboard GPS, IMUs, and magnetometers. The leader drone aggregates these states via a mesh network or direct peer-to-peer links. Each state is timestamped and synchronized to ensure consistency across the swarm. Environmental disturbances such as wind gusts or thermal currents may cause deviations in flight paths, which are reflected in the received state vectors. The leader stores these states in a buffer for real-time processing.

At step 202, the leader estimates a nominal system state

$${x}_{i}^{⋆} ( t ) ∈ {ℝ}^{9}$$

and a corresponding nominal control signal

$${u}_{i}^{⋆} ( t ) ∈ {ℝ}^{3}$$

for each follower drone. The nominal state is derived from a planned trajectory, which may be generated using a waypoint-based path planner or a coverage algorithm. The control signal includes desired thrust vector components or velocity commands. The model used is a linear time-invariant (LTI) approximation of the drone's dynamics:

$${\dot{x}}_{i}^{⋆} ( t ) = {Ax}_{i}^{⋆} ( t ) + {Bu}_{i}^{⋆} ( t ) ,$$

where A∈ [symbol] ^{9×9} and B∈ [symbol] ^{9×3}. These matrices encode translational and rotational dynamics and are stored in the leader's onboard memory. The nominal control signal is computed based on mission parameters and updated periodically.

At step 203, the leader computes an error signal

$${e}_{i} ( t ) = {x}_{i} ( t ) - {x}_{i}^{⋆} ( t ) ∈ {ℝ}^{9}$$

for each follower drone. This signal captures deviations from the planned trajectory due to environmental factors or internal disturbances. For example, a drone encountering a strong crosswind may drift laterally, resulting in a position error. The error signal may be decomposed into components such as lateral deviation, altitude error, and heading misalignment. The leader may apply a weighting matrix Wₑ∈ [symbol] ^{9×9} to prioritize certain error dimensions, such as proximity to obstacles or deviation from formation. The norm ∥eᵢ(t)∥₂ is computed and stored for use in the triggering condition.

At step 204, the leader generates an adjusted control signal

$${u}_{i} ( t ) = {u}_{i}^{⋆} ( t ) - L {e}_{i} ( t ) ∈ {ℝ}^{3} ,$$

where L∈ [symbol] ^{3×9} is a feedback matrix designed to stabilize the error dynamics. The matrix L may be computed using LQR methods with cost matrices Q_{L}∈ [symbol] ^{9×}and R_{L}∈ [symbol] ^{3×3}. For instance, Q_{L} may assign higher penalties to altitude deviations and heading errors, while R_{L} limits control effort. The adjusted control signal is constrained by actuator limits and may be filtered to prevent oscillations. This signal is stored for comparison with the previously transmitted control signal.

At step 205, the leader retrieves the previously transmitted control signal u_{i,s}(t)∈ [symbol] ³, which was last sent to drone i. This signal is held constant between events using a zero-order hold mechanism implemented in the drone's flight controller. The leader maintains a log of transmitted signals and timestamps to track update history. In scenarios with intermittent connectivity, the zero-order hold ensures that drones continue to operate safely using the last known command. This mechanism is critical in maintaining stability during communication outages or when drones enter signal shadows.

At step 206, the leader computes an alignment metric for each drone using the formula

$$2 {e}_{i}^{⊤} ( t ) PB ( {u}_{i , s} ( t ) - {u}_{i} ( t ) ) ,$$

where P∈ [symbol] ^{9×9} is a symmetric positive-definite matric satisfying the Lyapunov equation

$${A}_{e}^{⊤} P + {PA}_{e} + R = 0 .$$

The matrix R∈ [symbol] ^{9×9} may be designed to emphasize stability near target locations. For example, as a drone approaches a victim's last known location, the weights in R may increase to prioritize precision. The alignment metric quantifies whether the control correction is directionally aligned with the error, indicating the effectiveness of the update.

At step 207, the leader compares the alignment metric to a proximity-weighted condition:

$$2 {e}_{i}^{⊤} ( t ) PB ( {u}_{i , s} ( t ) - {u}_{i} ( t ) ) \leq α ( {d}_{i} ) {e}_{i}^{⊤} ( t ) {e}_{i} ( t ) ,$$

where α(dᵢ) is a scalar function of the drone's distance dᵢ to the target location. For example, α(dᵢ)=α₀+α₁/(1+dᵢ) increases as the drone nears the target. This adaptive threshold ensures that control updates are more frequent when precision is critical, such as during victim localization or payload delivery. If the condition is satisfied, the control update is suppressed; otherwise, it is transmitted.

At step 208, the leader transmits the adjusted control signal uᵢ(t) to drone i if the triggering condition is violated. The transmission occurs over a mesh network using a low-latency protocol with packet prioritization. The control signal may be encrypted and include a checksum for integrity verification. If the condition is satisfied, the previously transmitted signal u_{i,s}(t) is retained and applied. The drone executes the control signal using its motor controllers and navigation system. In critical zones, such as near collapsed structures, the drone may switch to a high-frequency update mode to ensure responsiveness. The error dynamics for each drone are governed by ėᵢ(t)=Aₑeᵢ(t)+B(u_{i,s}(t)−uᵢ(t)). The leader analyzes stability using the Lyapunov function

$$V ( {e}_{i} ) = {e}_{i}^{⊤} {Pe}_{i} ,$$

$$with derivative \dot{V} ( t ) = - {e}_{i}^{⊤} ( t ) R {e}_{i} ( t ) + 2 {e}_{i}^{⊤} ( t ) PB ( {u}_{i , s} ( t ) - {u}_{i} ( t ) ) .$$

Using the triggering condition, it follows that

$$\dot{V} ( t ) \leq - {e}_{i}^{⊤} ( t ) ( R - α ( {d}_{i} ) I ) {e}_{i} ( t ) ,$$

ensuring exponential convergence. This analysis guarantees that drones remain stable and converge to their planned paths even with sparse control updates.

The adaptive event-triggering mechanism provides significant benefits in search and rescue operations. By modulating control transmission frequency based on proximity to targets, the system balances communication efficiency with precision. Drones far from targets tolerate larger deviations, conserving bandwidth, while those near targets receive frequent updates for accurate positioning. This approach reduces network congestion, extends battery life, and improves mission success rates. The method is robust to environmental disturbances and scalable to large swarms.

The system components include a leader drone with a high-performance processor, memory, and communication module; follower drones with sensors, actuators, and flight controllers; and a mesh network for inter-drone communication. The leader stores matrices A, B, L, P, and R, as well as proximity functions α(dᵢ). Each drone logs its state, control history, and received commands. The system supports integration with ground control stations, mapping software, and victim detection algorithms. The method may support reliable coordination under bandwidth constraints and can be extended to heterogeneous swarms with varying dynamics.

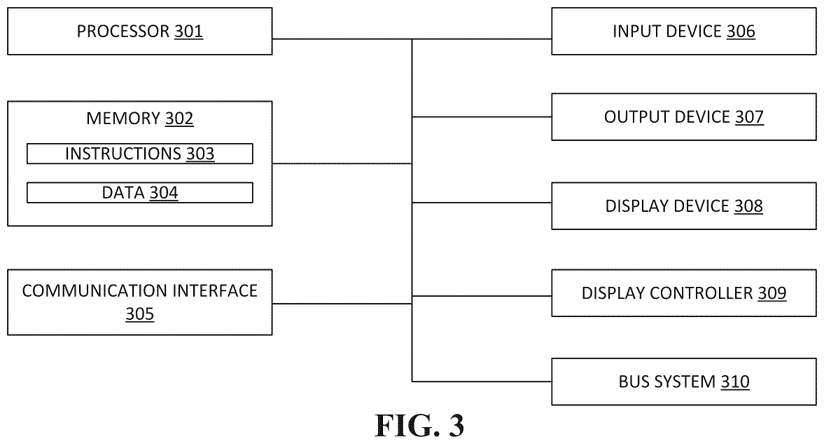

Referring now to FIG. 3, a schematic diagram illustrates an example system architecture 300 configured to implement control structure-agnostic event-triggering. The system 300 may correspond to the control device 110 described in FIG. 1, and may be used in conjunction with a controlled electronic device such as a robotic manipulator, autonomous vehicle, or drone. The system 300 may be configured to execute the method steps illustrated in FIG. 2, including receiving a system state, estimating a nominal state and control signal, computing an error signal, generating an adjusted control signal, and determining whether to transmit the adjusted control signal based on a triggering condition. The system 300 may be deployed in a wide range of applications, including remote robotic surgery, search and rescue drone swarms, industrial automation, and smart grid control.

The system 300 includes a processor 301, which may be implemented as a general-purpose microprocessor, a digital signal processor (DSP), a microcontroller, or a programmable logic device. The processor 301 may be configured to execute control logic for computing error signals, evaluating alignment metrics, and determining whether event-triggering conditions are satisfied, as described in steps 203, 206, and 207 of FIG. 2. In some embodiments, the processor 301 may include multiple cores or heterogeneous processing units, such as a combination of an ARM processor and a DSP, to support real-time control and signal processing. In the robotic surgery example, the processor 301 may be implemented as a real-time embedded processor with sensor interfaces and local memory buffers. In the drone swarm example, the processor 301 may be integrated into the leader drone's flight controller and configured to coordinate multiple follower drones.

The system 300 further includes memory 302 in electronic communication with the processor 301. The memory 302 may include volatile or non-volatile storage, such as RAM, ROM, flash memory, or solid-state drives. The memory 302 may store instructions and data used to implement the control structure-agnostic event-triggering framework. In some embodiments, the memory 302 may include a combination of on-chip and off-chip memory, and may support high-speed access for real-time control applications. The memory 302 may also store historical control signals, system state trajectories, and diagnostic logs for offline analysis and performance monitoring.

As shown in FIG. 3, the memory 302 contains two internal components: instructions 303 and data 304. These are represented as nested boxes within the memory block to reflect their logical containment. The instructions 303 may include executable routines for estimating nominal system states and control signals (step 202), computing error signals (step 203), generating adjusted control signals using a feedback matrix (step 204), and computing alignment metrics (step 206). The data 304 may include system state vectors, control signal histories, feedback matrices (e.g., L), alignment metric matrices (e.g., P), and triggering thresholds (e.g., α), all of which are used to evaluate the event-triggering condition (step 207). In the robotic surgery example, the memory 302 may store matrices A, B, L, P, and R, as well as timestamped sensor data and control logs. In the drone swarm example, the memory 302 may store proximity-based a functions and mission-specific trajectory plans.

A communication interface 305 may be included to transmit control signals to a controlled electronic device and receive system state measurements. The communication interface 305 may support wired or wireless protocols, including Ethernet, Wi-Fi, 5G, satellite relays, or mesh networks. In some embodiments, the communication interface 305 may include encryption, authentication, and error correction mechanisms to ensure secure and reliable data exchange. The communication interface 305 supports the claim limitation of receiving the system state either via measurement or over a network. In the robotic surgery example, the communication interface 305 may transmit control signals over a real-time protocol with encryption and error correction. In the drone swarm example, the communication interface 305 may operate over a mesh network with packet prioritization and adaptive update rates.

The system 300 may also include one or more input devices 306 and one or more output devices 307. Input devices 306 may include sensors, joysticks, haptic interfaces, or autonomous planning modules used to generate nominal control signals. Output devices 307 may include actuators, motors, speakers, or feedback indicators used to apply or visualize control actions. These components may support the generation and application of both nominal and adjusted control signals. In the robotic surgery example, input devices 306 may include haptic joysticks and foot pedals, while output devices 307 may include servo motors and force-feedback actuators. In the drone swarm example, input devices 306 may include mission planners and GPS modules, while output devices 307 may include thrust vector controllers and LED indicators.

A display device 308 may be provided to visualize system states, control signals, or triggering events. The display device 308 may utilize LCD, LED, or other projection technologies. A display controller 309 may convert stored data 304 into graphical representations or diagnostic feedback. These components may be used to monitor the performance of the event-triggering framework, visualize alignment metrics, or display alerts when triggering conditions are met. In some embodiments, the display controller 309 may support real-time rendering of control trajectories and system diagnostics. In the robotic surgery example, the display device 308 may show tool tip positions and alignment metrics to the surgeon. In the drone swarm example, the display device 308 may visualize swarm formation and proximity-based triggering thresholds.

The various components of the system 300 may be interconnected via a bus system 310, which may include data, control, and power buses. The bus system 310 may support high-speed communication between the processor 301, memory 302, communication interface 305, and peripheral devices. In some embodiments, the bus system 310 may be implemented using deterministic fieldbus protocols or real-time Ethernet. The bus system 310 ensures that all components operate in a synchronized and coordinated manner, which is essential for real-time control and event-triggered decision-making.

The system 300, as illustrated in FIG. 3, provides structural support for the method and system claims. The processor 301 and memory 302 correspond to the control device of claims 8 and 16. The instructions 303 and data 304 support the execution of steps (a) through (h) in both the method and system claims. The communication interface 305 supports receiving system state and transmitting control signals. The feedback matrix L and alignment metric matrix P, stored in data 304, support the computation of adjusted control signals and alignment metrics. The triggering condition, based on a scalar multiple of the error norm, is implemented using parameters stored in data 304 and logic encoded in instructions 303. The system 300 may be embodied in hardware, software, or a combination thereof, and may be deployed in safety-critical, bandwidth-constrained, or energy-limited environments.

### Example Implementations and Experiments

From the Lyapunov function V(x)=0.5x², it follows that V(x(t))=aₙx²(t)+x(t)(uₛ(t)−u(t)). At this point, a norm-based event rule [symbol] such as:

$$‖ {u}_{s} ( t ) - u ( t ) ‖ < α ‖ x ( t ) ‖ \qquad ( 1 )$$

or a norm-free¹ event rule [symbol] such as:

$$x ( t ) ( {u}_{s} ( t ) - u ( t ) ) \leq α {x}^{2} ( t ) \qquad ( 2 )$$

may be established, with α being a positive constant such that aₙ+α is negative. In either scenario, V(x(t))≤(aₙ+α)x²(t) holds, ensuring global exponential stability of the origin of the resulting closed-loop system.

The following scientific question naturally arises: How can an event rule be established using Lyapunov stability theory when the structure of the control signal remains unknown?

In certain cyber-physical-human systems, control laws may not possess a known structure in closed form, as when generated by humans, machine learning or artificial intelligence algorithms, or computational optimization or model predictive control methods. Motivated by this observation, this paper seeks to make the first attempt at addressing the above scientific question. Specifically, a novel control structure-agnostic event-triggering framework is proposed, relying solely on open-loop system dynamics in both continuous-and discrete-time settings. Alongside rigorous system-theoretical analysis, two illustrative numerical examples—one involving a human subject and the other a reinforcement learning strategy—are provided to demonstrate the efficacy of the proposed contribution.

The section concludes with mathematical notation. The sets [symbol] , [symbol] ₊, and [symbol] ₒ denote integers, positive integers, and nonnegative integers, respectively; [symbol] , [symbol] ₊, and [symbol] ₒ denote real numbers, positive real numbers, and nonnegative real numbers, respectively; and [symbol] ^{n×m}, [symbol] ^{n×n} and [symbol] ₊^{n×n} denote n×m real matrices, n×n positive-definite real matrices, and nxn nonnegative-definite real matrices, respectively. The notation (·)^{T} denotes the transpose, (·)⁻¹ the inverse, |·| the absolute value, and ∥·∥₂ the Euclidean norm. The symbol “ [symbol] ” indicates equality by definition.

### 2. Problem Definition

In this section, the control structure-agnostic event-triggering framework is proposed first in a continuous-time setting (see Section 2.1) and then in a discrete-time setting (see Section 2.2). The key feature of this framework is its reliance solely on open-loop system dynamics, without assuming knowledge of the original (i.e., non-event-triggered) control law's structure. As these results represent the introduction of a novel framework, the focus is on linear time-invariant systems with measurable states to ensure clarity.

### 2.1 Continuous-Time Setting

Consider the continuous-time linear time-invariant system G:

$$\dot{x} ( t ) = Ax ( t ) + {Bu}_{s} ( t ) , x ( 0 ) = {x}_{o} , \qquad ( 3 )$$

where x(t)∈ [symbol] ⁿ is a measurable state, uₛ(t)∈ [symbol] ^{m} is the sampled data version of a continuous-time control signal u(t)∈ [symbol] ^{m}, and A∈ [symbol] ^{n×n} and B∈ [symbol] ^{n×m} are the system and control input matrices with (A, B) controllable. The control signal C is defined as:

$$u ( t ) = {u}_{n} ( t ) - L ( x ( t ) - {x}_{n} ( t ) ) , \qquad ( 4 )$$

where uₙ(t)∈ [symbol] ^{m} is the original (non-event-triggered) control signal with unknown structure (the “nominal” control signal) and “−L (x(t)-xₙ(t))” is an additive term such that Aₑ=A−BL is Hurwitz for design matrix L∈ [symbol] ^{m×n}. This additive control is central to enabling the control structure-agnostic event-triggering framework by ensuring Aₑ is Hurwitz. The nominal state xₙ(t)∈ [symbol] ⁿ satisfies:

$$\begin{matrix}{\dot{x}}_{n} ( t ) = A {x}_{n} ( t ) + B {u}_{n} ( t ) , & {x}_{n} ( 0 ) = {x}_{{n}^{0}} .\end{matrix} \qquad ( 5 )$$

This represents the non-event-triggered dynamics driven by the nominal control signal uₙ(t).

Assumption 1: The original control signal uₙ is bounded and yields xₙ∈ [symbol] ₛ for xₙ_{⁰} ∈ [symbol] ₀, with [symbol] ₛ and [symbol] ₀ compact subsets of [symbol] ². While the nominal control signal uₙ(t) may lack a closed-form structure, it is expected to provide the desired closed-loop performance in the absence of event-triggering.

Define:

$$e ( t ) x ( t ) - {x}_{n} ( t ) \qquad ( 6 )$$

as the error signal. The norm-free event rule [symbol] is:

$$2 {e}^{T} ( t ) P B ( {u}_{s} ( t ) - u ( t ) ) \leq α {e}^{T} ( t ) e ( t ) \qquad ( 7 )$$

which schedules control data transmissions from controller C in (4) to system G in (3), where P∈ [symbol] ^{n×n} solves the continuous-time Lyapunov equation:

$${A}_{e}^{T} P + P {A}_{e} + R = 0 \qquad ( 8 )$$

for a user-specified matrix R∈ [symbol] ^{n×n}, and α∈ [symbol] ₊ is a design constant such that R−αIₙ∈ [symbol] ^{n×n}.

Problem 1: Given system G (3), control C (4), and event rule [symbol] (7), under Assumption 1 for uₙ(t), the objective is to show that e(t) exponentially vanishes.

### 2.2 Discrete-Time Setting

The discrete-time linear time-invariant system G is given by:

$$\begin{matrix}x ( k + 1 ) = Ax ( k ) + B {u}_{s} ( k ) , & x ( 0 ) = {x}_{0} ,\end{matrix} \qquad ( 9 )$$

where x(k)∈ [symbol] ⁿ is a measurable state, uₛ(k)∈ [symbol] ^{m} is the sampled data version of a discrete-time control signal u(k)∈ [symbol] ^{m} , and A∈ [symbol] ^{n×n}, B∈ [symbol] ^{n×m} are system and input matrices with (A, B) controllable. The control signal C is:

$$u ( k ) = {u}_{n} ( k ) - L ( x ( k ) - {x}_{n} ( k ) ) , \qquad ( 10 )$$

where uₙ∈ [symbol] ^{m} is the nominal control signal (unknown structure), with “−L (x(k)−xₙ(k))” ensuring Aₑ=A−B L is Schur for L∈ [symbol] ^{m×n} . The nominal state xₙ(k)∈ [symbol] ⁿ evolves as:

$$\begin{matrix}{x}_{n} ( k + 1 ) = A {x}_{n} ( k ) + B {u}_{n} ( k ) , & {x}_{n} ( 0 ) = {x}_{n 0} .\end{matrix} \qquad ( 11 )$$

Assumption 1 is similarly adopted.

Define:

$$e ( k ) = x ( k ) - {x}_{n} ( k ) \qquad ( 12 )$$

as the error signal. The norm-free event rule [symbol] is:

$${( 2 {A}_{e} e ( k ) + B ( {u}_{s} ( k ) - u ( k ) ) )}^{T} P B ( {u}_{s} ( k ) - u ( k ) ) \leq α {e}^{T} ( k ) e ( k ) \qquad ( 13 )$$

scheduling control data transmissions, with P∈ [symbol] ^{n×n} solving the discrete-time Lyapunov equation:

$${A}_{e}^{T} {PA}_{e} - P + R = 0 \qquad ( 14 )$$

for user-defined R∈ [symbol] ^{n×n}, and α∈ [symbol] so that R−αIₙ∈ [symbol] ^{n×n}.

Problem 2: For system G (9), control signal (10), and event rule [symbol] (13), under Assumption 1 for uₙ(k), the objective is to show that e(k) asymptotically or geometrically vanishes.

### 3. System-Theoretical Analyses

This section presents the system-theoretical analyses of Problems 1 and 2.

### 3.1 Analysis of the Continuous-Time Framework

For system G in (3), control C in (4), and event rule [symbol] in (7), adding and subtracting B u(t) to (3), and using (4), the closed-loop system is:

$$\dot{x} ( t ) = A x ( t ) + B {u}_{n} ( t ) - B L e ( t ) + B ( {u}_{s} ( t ) - u ( t ) ) \qquad ( 15 )$$

From (5) and (15), the error dynamics become:

$$\dot{e} ( t ) = {A}_{e} e ( t ) + B ( {u}_{s} ( t ) - u ( t ) ) \qquad ( 16 )$$

The first main result for the continuous-time case is as follows.

Theorem 1: For system G (3), control C (4), and event rule [symbol] (7), under Assumption 1, Problem 1 is addressed.

Proof: Consider the Lyapunov function:

$${V}_{1} ( e ) = {e}^{T} P e \qquad ( 17 )$$

Its derivative satisfies:

$${\dot{V}}_{1} ( t ) = - {e}^{T} ( t ) R e ( t ) + 2 {e}^{T} ( t ) P B ( {u}_{s} ( t ) - u ( t ) ) \qquad ( 18 )$$

Applying the event rule (7) in (18) yields:

$${V}_{1} ( t ) \leq - {e}^{T} ( t ) ( R - α {I}_{n} ) e ( t ) \qquad ( 19 )$$

Letting R₁ [symbol] R−α Iₙ, the upper bound is:

$${V}_{1} ( t ) \leq - {λ}_{min} ( {R}_{1} ) / {λ}_{max} ( P ) {V}_{1} ( t ) = - {β}_{1} {V}_{1} ( t ) \qquad ( 20 )$$

### Accordingly,

$${V}_{1} ( t ) \leq {V}_{10} exp ( - {β}_{1} t ) \qquad ( 21 )$$

where V₁₀=e₀^{T}P e₀. The origin of (16) is thus globally exponentially stable.

Remark 1: To prevent potential Zeno behavior or further reduce transmissions, a small bias β may be added to the right side of (7) as g(·)=αe^{T}(t)e(t)+β (see, e.g., Remark 8 of Kurtoglu et al. (2023a)). In this case, e(t) remains bounded, with its ultimate bound becoming arbitrarily small for sufficiently small β.

### 3.2 Analysis of the Discrete-Time Framework

For system G (9), control C (10), and event rule [symbol] (13), adding and subtracting B u(k) to (9) and using (10) gives:

$$x ( k + 1 ) = Ax ( k ) + {Bu}_{n} ( k ) - BLe ( k ) + B ( {u}_{s} ( k ) - u ( k ) ) \qquad ( 22 )$$

From (11) and (22), the error dynamics become:

$$e ( k + 1 ) = {A}_{e} e ( k ) + B ( {u}_{s} ( k ) - u ( k ) ) \qquad ( 23 )$$

The main result for the discrete-time case:

Theorem 2: For system G (9), control C (10), and event rule [symbol] (13), under Assumption 1, Problem 2 is addressed.

Proof: Consider the Lyapunov function:

$${V}_{2} ( e ) = {e}^{T} Pe \qquad ( 24 )$$

The Lyapunov difference is:

$$Δ {V}_{2} = {V}_{2} ( e ( k + 1 ) ) - {V}_{2} ( e ( k ) ) = {( {A}_{e} e ( k ) + B ( {u}_{s} ( k ) - u ( k ) ) )}^{T} P ( {A}_{e} e ( k ) + B ( {u}_{s} ( k ) - u ( k ) ) ) - {e}^{T} ( k ) Pe ( k ) = - {e}^{T} ( k ) Re ( k ) + 2 {e}^{T} ( k ) {A}_{e}^{T} PB ( {u}_{s} ( k ) - u ( k ) ) + {( {u}_{s} ( k ) - u ( k ) )}^{T} {B}^{T} PB ( {u}_{s} ( k ) - u ( k ) ) \qquad ( 25 )$$

Applying the event rule (13) in (25) yields:

$$Δ {V}_{2} \leq - {e}^{T} ( k ) ( R - α {I}_{n} ) e ( k ) \qquad ( 26 )$$

Letting R₂ [symbol] R−α Iₙ, the upper bound is:

$$Δ {V}_{2} \leq - {λ}_{min} ( {R}_{2} ) / {λ}_{max} ( P ) {V}_{2} ( e ( k ) ) = - {β}_{2} {V}_{2} ( e ( k ) ) \qquad ( 27 )$$

where β₂=λₘᵢₙ(R₂)/λₘₐₓ(P), further implying:

$$p {V}_{2} ( e ( k + 1 ) ) \leq {V}_{2} ( e ( k ) ) , p = 1 / ( 1 - {β}_{2} ) \qquad ( 28 )$$

If p>1 in (28), then the origin of (23) is globally geometrically stable:

$${‖ e ( k ) ‖}^{2} \leq ( {λ}_{max} ( P ) / {λ}_{min} ( P ) ) {‖ {e}_{0} ‖}^{2} ( {p}^{∧} - k ) \qquad ( 29 )$$

$$where {e}_{0} = {x}_{0} - {x}_{n 0} .$$

### 4. Illustrative Numerical Examples

4.1 Event-Triggering with Human-in-the-Loop

Consider the continuous-time dynamical system G as in (3), with:

$$A = [ [ 0 , 1 ] , [ 0 , 0 ] ] , B = [ [ 0 ] , [ 1 ] ] \qquad [ 30 ]$$

Here, α=0.9 is chosen for event rule [symbol] (7). Consistent with Remark 1, a small constant β=0.001 is added to the right side of the event rule to avoid potential Zeno behavior. In this setup, uₙ(t) in control signal C (4) represents a trained human subject. The first state of the nominal model (5) is visually fed back to the subject, whose task is to drive this state to one by applying the signal uₙ(t) using a software slider operated via a mouse.

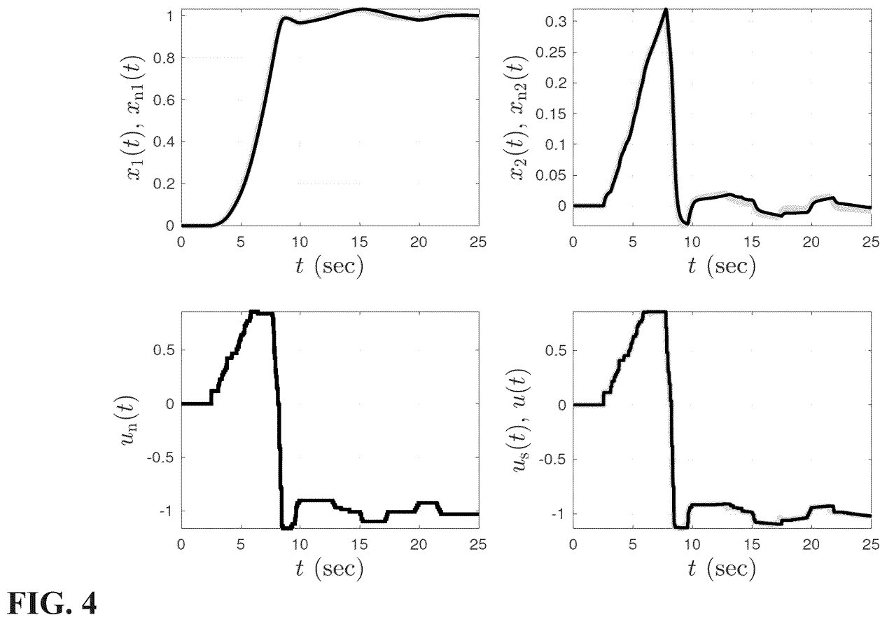

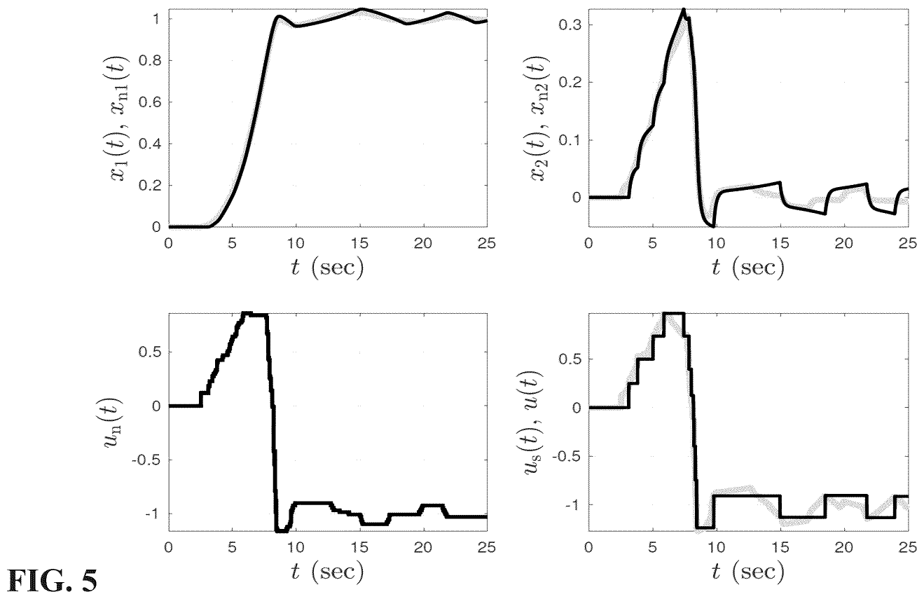

FIGS. 4 and 5 display the results, with L chosen to assign the eigenvalues of Aₑ as −0.1and −0.5 in the first figure, and −1 and −5 in the second. The same recorded signal uₙ(t) is used in all cases, yielding 206 events for the first case and 17 events for the second case under the proposed framework.

Note that the human subject can apply a control signal after the first 2.5 seconds, with a total simulation time of 22.5 seconds at 200 Hertz, resulting in 4500 control data transmissions without event-triggering. The proposed framework achieves 95.42% and 99.62% reductions in control data transmissions in these cases, respectively. Additionally, the number of events decreases as the eigenvalues of Aₑ become larger.

4.2 Event-Triggering with Reinforcement Learning

Consider the discrete-time dynamical system G as in (9), with:

$$A = [ [ 1 , 0.01 ] , [ 0 , 1 ] ] , B = [ [ 0 ] , [ 0.01 ] ] , {x}_{0} = [ [ 0 ] , [ 0 ] ] \qquad [ 31 ]$$

Here, α=0.9 for event rule [symbol] (13), and a small constant β=0.001 is again employed.

In this scenario, uₙ(k) in control signal C (10) represents a reinforcement learning strategy. Specifically, Q-learning is employed within defined bounds for nominal model states and the uₙ(k) signal. The state space for the first and second nominal model states is partitioned into 250 samples within [−0.25, 1.25] and [−0.25, 0.5], respectively. The uₙ(k) signal actions are quantized across [−1, 1] with 0.05 increments.

The Q-table, initialized at zero for each combination of nominal model states and signal, is updated using an epsilon-greedy strategy to balance exploration and exploitation. This setup enables iterative determination of the uₙ(k) signal based on reward feedback that includes deviation minimization from an ideal trajectory (a ramp for the first state and its constant slope for the second).

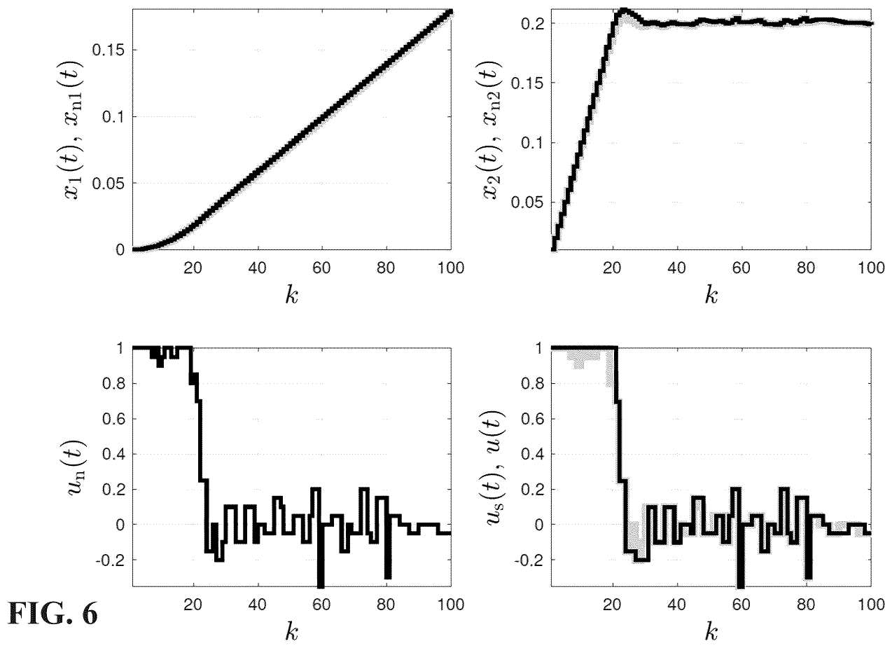

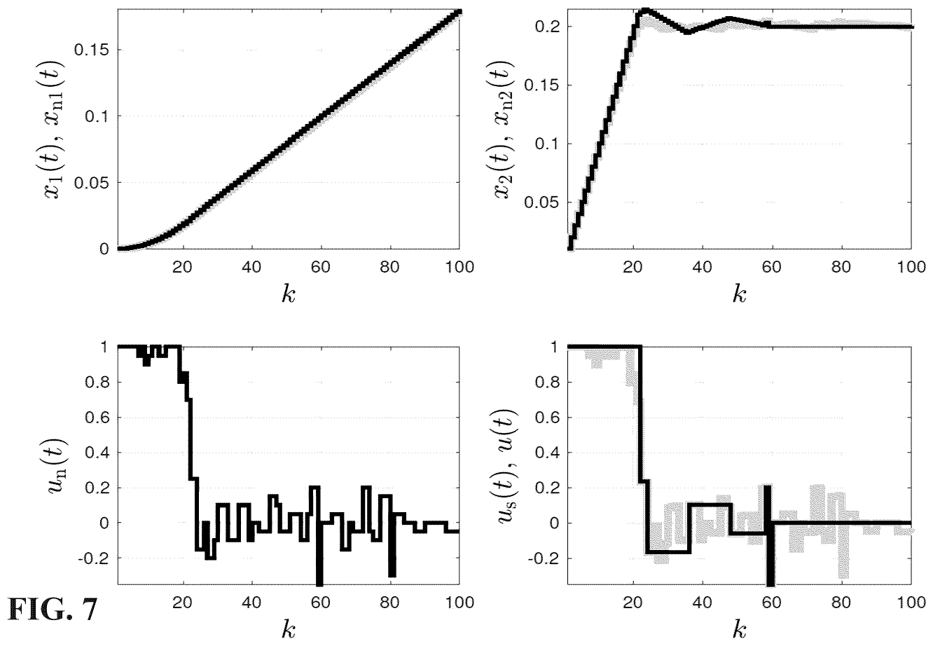

FIGS. 6 and 7 show the results, with L chosen via discrete linear quadratic regulator theory (Q_L∈ [symbol] 2x2, R_L∈ [symbol] ) to minimize:

$$\sum k ( {e}^{T} ( k ) Q\_Le ( k ) + {u}^{T} ( k ) R\_Lu ( k ) ) , {u}_{r} ( k ) = - L e ( k )$$

Here, Q_L=I for both figures, and R_L=100 and R_L=1 in the first and second figures, respectively. The same recorded signal uₙ(k) is used, with the proposed framework resulting in 33 events for the first case and 8 events for the second.

The total simulation interval is k∈[0, 100], yielding 67% and 92% reductions in control data transmissions, respectively. The number of events decreases as R_L decreases up to a certain value.

Embodiments of the present disclosure may thus utilize a special purpose or general-purpose computing system including computer hardware, such as, for example, one or more processors and system memory. Embodiments within the scope of the present disclosure also include physical and other computer-readable media for carrying or storing computer-executable instructions and/or data structures, including applications, tables, data, libraries, or other modules used to execute particular functions or direct selection or execution of other modules. Such computer-readable media can be any available media that can be accessed by a general purpose or special purpose computer system. Computer-readable media that store computer-executable instructions (or software instructions) are physical storage media. Computer-readable media that carry computer-executable instructions are transmission media. Thus, by way of example, and not limitation, embodiments of the present disclosure can include at least two distinctly different kinds of computer-readable media, namely physical storage media or transmission media. Combinations of physical storage media and transmission media should also be included within the scope of computer-readable media.

Both physical storage media and transmission media may be used temporarily store or carry software instructions in the form of computer readable program code that allows performance of embodiments of the present disclosure. Physical storage media may further be used to persistently or permanently store such software instructions. Examples of physical storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored as or in software, hardware, firmware, or combinations thereof.

A “network” or “communications network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instructions or data structures and which can be accessed by a general purpose or special purpose computer.

Further, upon reaching various computer system components, program code in the form of computer-executable instructions or data structures can be transferred automatically or manually from transmission media to physical storage media (or vice versa). For example, computer-executable instructions or data structures received over a network or data link can be buffered in memory (e.g., RAM) within a network interface module (NIC), and then eventually transferred to computer system RAM and/or to less volatile physical storage media at a computer system. Thus, it should be understood that physical storage media can be included in computer system components that also (or even primarily) utilize transmission media.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

As used in this specification and the claims, the singular forms “a,” “an,” and “the” include plural forms unless the context clearly dictates otherwise. The articles “a,” “an,” and “the” are intended to mean that there are one or more of the elements in the preceding descriptions. The terms “comprising,” “including,” and “having” are intended to be inclusive and mean that there may be additional clements other than the listed elements. Additionally, it should be understood that references to “one embodiment” or “an embodiment” of the present disclosure are not intended to be interpreted as excluding the existence of additional embodiments that also incorporate the recited features. For example, any clement described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims. Any trademarks mentioned herein are the property of their respective owners.

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean up to plus or minus 10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and allowing the inclusion only of additional components that do not fundamentally alter the nature of the claimed subject matter. Any trademarks are the property of their respective owners.

The phrase “such as” should be interpreted as “for example, including.” Moreover, the use of any and all example language, including but not limited to “such as”, is intended merely to better illuminate the invention and does not pose a limitation on the scope of the invention unless otherwise claimed.

Furthermore, in those instances where a convention analogous to “at least one of A, B and C, etc.” is used, in general such a construction is intended in the sense of one having ordinary skill in the art would understand the convention (e.g., “a system having at least one of A, B and C” would include but not be limited to systems that have A alone, B alone, C alone, A and B together, A and C together, B and C together, and/or A, B, and C together.). It will be further understood by those within the art that virtually any disjunctive word and/or phrase presenting two or more alternative terms, whether in the description or figures, should be understood to contemplate the possibilities of including one of the terms, either of the terms, or both terms. For example, the phrase “A or B” will be understood to include the possibilities of “A” or “B” or “A and B.”

All language such as “up to,” “at least,” “greater than,” “less than,” and the like, include the number recited and refer to ranges which can subsequently be broken down into ranges and subranges. A range includes each individual member. Thus, for example, a group having 1-3 members refers to groups having 1, 2, or 3 members. Similarly, a group having 6 members refers to groups having 1, 2, 3, 4, or 6 members, and so forth.

The modal verb “may” refers to the preferred use or selection of one or more options or choices among the several described embodiments or features contained within the same. Where no options or choices are disclosed regarding a particular embodiment or feature contained in the same, the modal verb “may” refers to an affirmative act regarding how to make or use an aspect of a described embodiment or feature contained in the same, or a definitive decision to use a specific skill regarding a described embodiment or feature contained in the same. In this latter context, the modal verb “may” has the same meaning and connotation as the auxiliary verb “can.”

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for scheduling control data transmissions in a control system, the method comprising:
receiving a system state of a controlled electronic device;
estimating a nominal system state and a corresponding nominal control signal based on a model of the controlled electronic device;
determining an error signal as a difference between the received system state and the estimated nominal system state;
generating an adjusted control signal by modifying the nominal control signal based on the error signal using a feedback matrix;
retrieving a previously transmitted control signal;
computing an alignment metric based on a directional comparison between the error signal and a difference between the adjusted control signal and the previously transmitted control signal;
comparing the alignment metric to a condition based on the magnitude of the error signal;
transmitting the adjusted control signal in response to the alignment metric satisfying the condition.

2. The method of claim 1, wherein receiving the system state comprises either measuring the system state using a sensor or receiving the system state over a communication network.

3. The method of claim 1, wherein the model of the controlled electronic device comprises a linear time-invariant representation of the behavior of the controlled electronic device.

4. The method of claim 3, wherein the linear time-invariant representation includes a feedback matrix determined such that a corresponding closed-loop system matrix is Hurwitz for continuous-time operation or Schur for discrete-time operation.

5. The method of claim 1, wherein the directional comparison comprises computing a matrix-weighted inner product between the error signal and the difference between the adjusted control signal and the previously transmitted control signal.

6. The method of claim 5, wherein the matrix used in the matrix-weighted inner product is a symmetric positive-definite matrix determined to satisfy a Lyapunov inequality.

7. The method of claim 1, wherein the condition comprises a comparison between the alignment metric and a scalar multiple of a norm of the error signal.

8. A system comprising a control device configured to schedule control data transmissions in a control system, the control device comprising:
a processor; and
a memory storing instructions that, when executed by the processor, cause the control device to:
(a) receive a system state of a controlled electronic device;
(b) estimate a nominal system state and a corresponding nominal control signal based on a model of the controlled electronic device;
(c) determine an error signal as a difference between the received system state and the estimated nominal system state;
(d) generate an adjusted control signal by modifying the nominal control signal based on the error signal using a feedback matrix;
(e) retrieve a previously transmitted control signal;
(f) compute an alignment metric based on a directional comparison between the error signal and a difference between the adjusted control signal and the previously transmitted control signal;
(g) compare the alignment metric to a condition based on the magnitude of the error signal; and
(h) transmit the adjusted control signal in response to the alignment metric satisfying the condition.

9. The system of claim 8, wherein receiving the system state comprises either measuring the system state using a sensor or receiving the system state over a communication network.

10. The system of claim 8, wherein the model of the controlled electronic device comprises a linear time-invariant representation of the behavior of the controlled electronic device.

11. The system of claim 10, wherein the linear time-invariant representation includes a feedback matrix determined such that a corresponding closed-loop system matrix is Hurwitz for continuous-time operation or Schur for discrete-time operation.

12. The system of claim 8, wherein the directional comparison comprises computing a matrix-weighted inner product between the error signal and the difference between the adjusted control signal and the previously transmitted control signal.

13. The system of claim 12, wherein the matrix used in the matrix-weighted inner product is a symmetric positive-definite matrix determined to satisfy a Lyapunov inequality.

14. The system of claim 8, wherein the condition comprises a comparison between the alignment metric and a scalar multiple of a norm of the error signal.

15. The system of claim 8, further comprising the controlled electronic device, wherein the controlled electronic device is configured to operate in response to the adjusted control signal transmitted by the control device.

16. A non-transitory computer-readable medium storing instructions executable to cause a control device to:
(a) receive a system state of a controlled electronic device;
(b) estimate a nominal system state and a corresponding nominal control signal based on a model of the controlled electronic device;
(c) determine an error signal as a difference between the received system state and the estimated nominal system state;
(d) generate an adjusted control signal by modifying the nominal control signal based on the error signal using a feedback matrix;
(e) retrieve a previously transmitted control signal;
(f) compute an alignment metric based on a directional comparison between the error signal and a difference between the adjusted control signal and the previously transmitted control signal;
(g) compare the alignment metric to a condition comprising a comparison between the alignment metric and a scalar multiple of a norm of the error signal; and
(h) transmit the adjusted control signal in response to the alignment metric satisfying the condition.

17. The non-transitory computer-readable medium of claim 16, wherein the model of the controlled electronic device comprises a linear time-invariant representation of the behavior of the controlled electronic device.

18. The non-transitory computer-readable medium of claim 17, wherein the linear time-invariant representation includes a feedback matrix determined such that a corresponding closed-loop system matrix is Hurwitz for continuous-time operation or Schur for discrete-time operation.

19. The non-transitory computer-readable medium of claim 16, wherein the directional comparison comprises computing a matrix-weighted inner product between the error signal and the difference between the adjusted control signal and the previously transmitted control signal.

20. The non-transitory computer-readable medium of claim 19, wherein the matrix used in the matrix-weighted inner product is a symmetric positive-definite matrix determined to satisfy a Lyapunov inequality.
